(19) United States
(12) Patent Application Publication
(10) Pub. No.: US 2025/0114842 A1
(43) Pub. Date: Apr. 10, 2025

(54) SINTERED MEMBER AND MANUFACTURING METHOD THEREOF

(71) Applicant: TOYOTA JIDOSHA KABUSHIKI KAISHA, Toyota-shi (JP)

(72) Inventors: Hiroaki HATSUYAMA, Toyota-shi (JP); Masaki SUGIYAMA, Toyota-shi (JP); Yasuhiro KATSUKAWA, Toyota-shi (JP); Katsumi ICHIJIMA, Takahama-shi (JP)

(73) Assignee: TOYOTA JIDOSHA KABUSHIKI KAISHA, Toyota-shi (JP)

(21) Appl. No.: 18/817,907

(22) Filed: Aug. 28, 2024

(30) Foreign Application Priority Data
Oct. 10, 2023 (JP) 2023-175516

(51) Int. Cl. B22F 5/00; B22F 3/16; B23K 35/02; B23K 35/30; C22C 30/02; C22C 38/16

(52) U.S. Cl. CPC B22F 5/00; B22F 3/16; B23K 35/025; B23K 35/302; C22C 30/02; C22C 38/16; B22F 2301/35; B22F 2998/10; B22F 2999/00

(57) ABSTRACT

A sintered member according to an aspect of the present disclosure includes a single powder compact made of a metal powder and having a stepped part, the powder compact being obtained by sintering. At a surface of a recessed corner part of the stepped part, a brazing material penetrates gaps between sintered metal powder particles.

### CROSS REFERENCE TO RELATED APPLICATIONS

This application is based upon and claims the benefit of priority from Japanese patent application No. 2023-175516, filed on Oct. 10, 2023, the disclosure of which is incorporated herein in its entirety by reference.

### BACKGROUND

The present disclosure relates to a sintered member and a manufacturing method thereof.

A method for compressing metal powder such as Fe-based metal powder with a lower punch and an upper punch in a die, for example, to mold a powder compact, and sintering the powder compact to manufacture a sintered member is known. For example, Patent Literature 1 discloses a multi-staged forming apparatus for molding a powder compact having a stepped part.

Patent Literature 1: Japanese Unexamined Patent Application Publication No. 2014-091143

### SUMMARY

The inventors found the following problems with a sintered member formed by sintering a powder compact having a stepped part and a manufacturing method thereof.

In a powder compact having a stepped part, at the time of molding of the powder compact, a crack and insufficient density are generated in the recessed corner part of the stepped part, and as a result, a defect such as insufficient strength of the sintered member is prone to occur.

The present disclosure has been made in view of the circumstances described above, and provides a sintered member and a manufacturing method thereof each adapted to suppress insufficient strength caused by a crack and insufficient density generated in a recessed corner part of a stepped part of a powder compact.

According to an aspect of the present disclosure, a sintered member includes a single powder compact made of a metal powder and having a stepped part, the powder compact being obtained by sintering, wherein
at a surface of a recessed corner part of the stepped part, a brazing material penetrates gaps between sintered metal powder particles.

According to an aspect of the present disclosure, at a surface of a recessed corner part of a stepped part, a brazing material penetrates gaps between sintered metal powder particles. Therefore, a crack and insufficient density generated in the recessed corner part of the stepped part at the time of molding of the powder compact can be eliminated, and the strength deficiency of the sintered member obtained by sintering the powder compact can be suppressed.

The metal powder may be Fe-based metal powder, and the brazing material may be a Cu—Ni—Mn-based brazing material. Such a configuration is suitable.

According to an aspect of the present disclosure, a method of manufacturing a sintered member includes:
preparing a single powder compact made of a metal powder and having a stepped part;
disposing a brazing material on a surface of a recessed corner part of the stepped part; and
sintering the powder compact on which the brazing material is disposed.

In a method of manufacturing a sintered member according to an aspect of the present disclosure, a brazing material is disposed on a surface of a recessed corner part of a stepped part of the powder compact, and then the powder compact is sintered. Therefore, at the surface of the recessed corner part of the stepped part, a molten brazing material penetrates gaps between metal powder particles to be sintered. Accordingly, a crack and insufficient density generated in the recessed corner part of the stepped part at the time of molding of the powder compact can be eliminated, and lack of strength of the sintered member obtained by sintering the powder compact can be suppressed.

The brazing material may be pasty and disposed on the surface of the recessed corner part of the stepped part by being applied thereon. With this configuration, a brazing material can be easily disposed on the surface of the recessed corner part of the stepped part.

The metal powder may be Fe-based metal powder, and the brazing material may be a Cu—Ni—Mn-based brazing material. Such a configuration is a suitable configuration.

According to the present disclosure, it is possible to provide a sintered member and a manufacturing method thereof adapted to suppress lack of strength caused by a crack and insufficient density generated in a recessed corner part of a stepped part of a powder compact.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view of a sintered member according to a first embodiment;

FIG. 2 is a cross-sectional view of a sintered member according to the first embodiment;

FIG. 3 is a flowchart showing a method of manufacturing a sintered member according to the first embodiment;

FIG. 4 is a photograph of a cross-sectional structure of a recessed corner part of a stepped part of a sintered member according to the first embodiment;

FIG. 5 is a photograph of a cross-sectional structure of a recessed corner part of a stepped part of a sintered member according to a second embodiment; and

FIG. 6 is a reflected electron image and an elemental mapping image of Fe, Cu, Ni, Mn, and C in region VI of FIG. 4.

### DESCRIPTION OF EMBODIMENTS

Hereinafter, a specific embodiment of the present disclosure will be described in detail with reference to the drawings. However, the present disclosure is not limited to the following embodiment. In addition, for clarity of explanation, the following description and drawings are simplified as appropriate.

### First Embodiment

### Configuration of Sintered Member

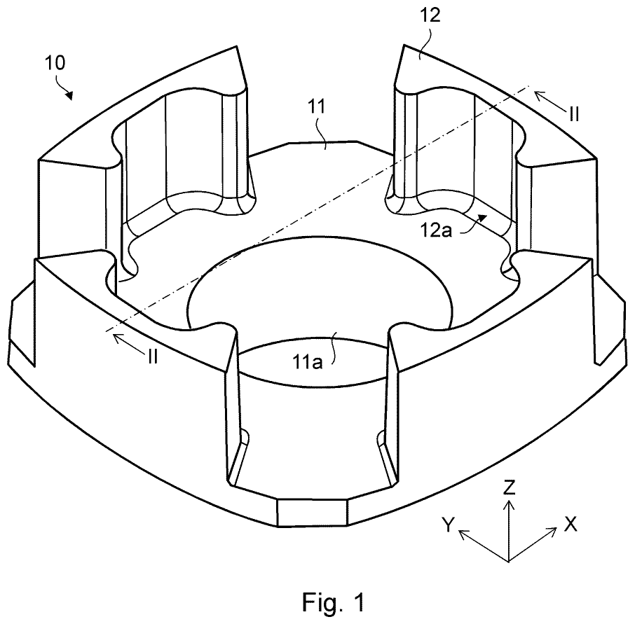

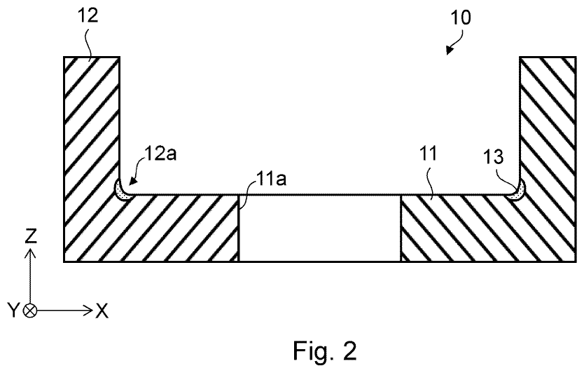

First, a configuration of a sintered member according to a first embodiment will be described with reference to FIGS. 1 and 2. FIG. 1 is a perspective view of a sintered member according to the first embodiment. FIG. 2 is a cross-sectional view of s sintered member according to the first embodiment. The sintered member shown in FIGS. 1 and 2 is, as an example, a sintered member for automotive use, more specifically, a planetary carrier.

Engine components such as pulleys, sprockets, oil pump components, crankshaft and camshaft bearing caps, manual transmission components such as synchro hubs and shift fingers, and automatic transmission components such as turbine hubs can be listed as an example of a sintered member for an automobile to which the present embodiment is applicable.

The sintered member according to the present embodiment is not limited to automotive components, but may also be magnets, motor cores, motor rotors, reactor cores, blade tools, and the like. Furthermore, although the sintered member according to the present embodiment is an Fe-based sintered member, it may be a sintered member made of a metal material mainly composed of Cu, Ni, Co, Ti, W, Mo, and the like.

FIGS. 1 and 2 show the right-handed XYZ orthogonal coordinates merely for the sake of convenience in explaining the positional relationship of the components. In FIGS. 1 and 2, the positive direction of the Z axis is vertically upward and the XY plane is a horizontal plane, which are common throughout the drawings. The cross-sectional view shown in FIG. 2 corresponds to the cross-sectional view taken along the line II-II in FIG. 1.

A sintered member 10 shown in FIGS. 1 and 2 includes a base part 11 and four stepped parts 12.

As shown in FIGS. 1 and 2, the base part 11 is a plate-like part that is approximately square in XY plane view. Each of the four sides of the base part 11 is curved so as to protrude outward. A circular through hole 11a is provided in the center of the base part 11.

Each stepped part 12 extends along each of the 4 sides of the base part 11 and is provided so as to project in the Z-axis positive direction. Both ends of the stepped part 12 in the longitudinal direction project inward the base part 11 (the through hole 11a side).

A recessed corner part 12a of the stepped part 12 is subjected to R-chamfering.

The sintered member 10 is obtained by sintering a single powder compact formed of metal powder and having a stepped part. That is, the sintered member 10 is not obtained by performing brazing on a plurality of powder compacts or sintered bodies.

On the other hand, the sintered member 10 is manufactured by disposing a brazing material on the surface of the recessed corner part 12a of the stepped part 12 of the powder compact and then performing sintering. Therefore, as shown in FIG. 2, on the surface part of the recessed corner part 12a of the stepped part 12 of the sintered member 10, a penetration part 13 in which the brazing material penetrates gaps between sintered metal powder particles is formed.

For example, a pasty brazing material is applied on the surface of the recessed corner part 12a of the stepped part 12, and then the powder compact is sintered. A pasty brazing material is a mixture of a brazing material powder made of a metal material and an organic binder. Alternatively, a powder compact formed of a brazing material powder made of a metal material may be disposed on the surface of the recessed corner part 12a. The average particle size D50 of the brazing material powder is not particularly limited, but is, for example, about 20-50 μm.

The brazing material is appropriately selected according to the type of the metal powder constituting the powder compact. When the powder compact is composed of Fe-based metal powder, Cu—Ni—Mn-based brazing material is selected, for example. For example, an Fe-based alloy containing small amounts of Cu and C is used for Fe-based metal powder constituting the powder compact. The average particle size D50 of the Fe-based metal powder constituting the powder compact is, for example, about 20-300 μm, although it is not particularly limited.

When the Cu—Ni—Mn-based brazing material melts and penetrates gaps between the Fe-based metal powder particles, the melting point of the Cu—Ni—Mn-based brazing material rises due to the reaction with Fe, whereby the Cu—Ni—Mn-based brazing material re-solidifies. Therefore, the Cu—Ni—Mn-based brazing material can remain on the surface part of the recessed corner part 12a of the stepped part 12, and it is possible to eliminate a crack and insufficient density generated in the recessed corner part 12a. Here, the brazing material may contain, for example, about 10% to 20% Fe-based metal powder constituting the powder compact in addition to the Cu—Ni—Mn-based brazing material powder.

The aforementioned brazing material is generally referred to as a Cu—Ni—Mn-based brazing material, but in some cases the Ni concentration is higher than the Cu concentration, and it may also be referred to as Ni—Cu—Mn-based brazing material.

As described above, in manufacturing the sintered member 10, at the time of molding of the powder compact, a crack and insufficient density might be generated in the recessed corner part 12a which is at the root of the stepped part 12.

However, in the sintered member 10 according to the present embodiment, at the surface of the recessed corner part 12a of the stepped part 12 at the time of sintering, a molten brazing material penetrates gaps between the metal powder particles to be sintered. Therefore, a crack and insufficient density generated in the recessed corner part 12a of the stepped part 12 at the time of molding of the powder compact can be eliminated, and the strength deficiency of the sintered member 10 obtained by sintering the powder compact can be suppressed.

When the density of the powder compact is increased, while the strength of the sintered member 10 is improved, a crack is apt to be generated at the time of molding of the powder compact. In other words, even when a crack is generated at the time of molding of the powder compact due to an increase in the density of the powder compact, such crack and insufficient density in the recessed corner part can be eliminated due to the brazing material penetrating gaps between the metal powder particles at the time of sintering. Therefore, the density of the powder compact can be increased and the strength of the sintered member 10 can be improved.

The shape, use, etc. of the sintered member according to the present embodiment are not limited in any way as long as it is obtained by sintering a single powder compact formed of a metal powder and having a stepped part.

For example, in the sintered member 10 shown in FIGS. 1 and 2, the base part 11 may have a circular shape in plan view or any other shape. The through hole 11a provided in the base part 11 is not essential, and the shape of the through hole 11a is not limited to a circular shape. The position, shape, number, etc. of the stepped part 12 can also be changed as appropriate.

The penetration part 13 shown in FIG. 2 is formed on the whole of the recessed corner part 12a of the stepped part 12 shown in FIG. 1, but may be formed on only a part of the recessed corner part 12a. For example, the penetration part 13 shown in FIG. 2 may be formed on only a part of the recessed corner part 12a where a crack and insufficient density are prone to occur. This configuration can reduce the amount of brazing material used.

On the other hand, for example, the penetration part 13 may be formed over a wider area including the recessed corner part 12a so as to span from the inner surface of the stepped part 12 to the upper surface of the base 11. That is, the penetration part 13 may be formed over a wider area than the penetration part 13 shown in FIG. 2.

Here, the penetration part 13 shown in FIG. 2 is only shown schematically, and does not accurately indicate the area, depth, etc. of the penetration part 13 penetrated by the brazing material.

### Method of Manufacturing Sintered Member According to the First Embodiment

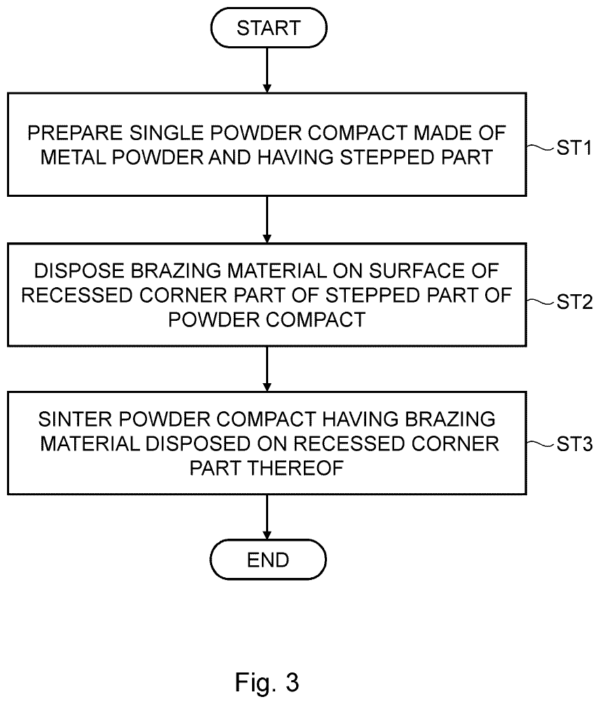

Next, a manufacturing method of a sintered member according to the first embodiment will be described with reference to FIG. 3. FIG. 3 is a flowchart showing a method of manufacturing a sintered member according to the first embodiment.

First, as shown in FIG. 3, a single powder compact formed of a metal powder and having the stepped part 12 is prepared (Step ST1). The powder compact having the stepped part 12 is manufactured, for example, by multistage formation, although it is not particularly limited thereto.

Next, as shown in FIG. 3, a brazing material is disposed on the surface of the recessed corner part 12a of the stepped part 12 of the powder compact (Step ST2). For example, a pasty brazing material is disposed on the surface of the recessed corner part 12a by being applied on the surface of the recessed corner part 12a of the stepped part 12. Alternatively, a powder compact formed of a brazing material powder made of a metal material may be disposed on the surface of the recessed corner part 12a. Use of a pasty brazing material facilitates disposing of the brazing material on the surface of the recessed corner part of the stepped part.

Finally, as shown in FIG. 3, the powder compact having the brazing material disposed on the surface of the recessed corner part 12a thereof is sintered (Step ST3). For example, the powder compact is placed inside a sintering furnace, and then the powder compact is heated to a predetermined temperature and sintered. In Step ST3, at the surface of the recessed corner part 12a, a molten brazing material penetrates gaps between the metal powder particles to be sintered to form the penetration part 13 shown in FIG. 2.

As described above, in the method of manufacturing a sintered member according to the present embodiment, a brazing material is disposed on the surface of the recessed corner part 12a of the stepped part 12 of the powder compact (Step ST2), and then the powder compact is sintered to thereby obtain the sintered member 10 (Step ST3). Therefore, at the surface of the recessed corner part 12a at the time of sintering, a molten brazing material penetrates gaps between the metal powder particles to be sintered to thereby form the penetration part 13 shown in FIG. 2. Therefore, a crack and insufficient density generated in the recessed corner part 12a of the stepped part 12 at the time of molding of the powder compact can be eliminated, and the strength deficiency of the sintered member 10 obtained by sintering the powder compact can be suppressed.

Hereinafter, the sintered member 10 according to the first embodiment and a manufacturing method thereof will be described in detail with reference to Examples. However, the sintered member 10 according to the first embodiment and a manufacturing method thereof are not limited to the following Examples.

### EXAMPLES

First, a single powder compact formed of an Fe-based alloy (Fe-2.0 mass % Cu-0.9 mass % C) powder with the stepped part 12 was prepared (Step ST1). The powder compact had the same shape as that of the sintered member 10 shown in FIGS. 1 and 2, and was molded by multistage formation. Here, the powder compact was molded so that a crack was generated in a predetermined recessed corner part 12a in the stepped part 12.

Next, a brazing material was disposed on the surface of the recessed corner part 12a of the stepped part 12 of the powder compact (Step ST2). Specifically, a pasty brazing material was applied on the surface of the recessed corner part 12a of the stepped part 12. The pasty brazing material is a mixture of a Cu—Ni—Mn-based alloy (Cu-41.5 mass % Ni-15 mass % Mn-1.8 mass % Si-1.5 mass % B) powder, and an organic binder. In addition, the brazing material further contains Fe-based alloy (Fe-2.0 mass % Cu-0.9 mass % C) powder constituting the powder compact. The mass ratio of the Cu—Ni—Mn-based alloy powder to the Fe-based alloy in the brazing material was 85:15.

Next, the powder compact with the brazing material disposed on the surface of the recessed corner part 12a was sintered in a sintering furnace to thereby obtain the sintered member 10 (Step ST3). The sintering condition was set to 1120° C. for 20 minutes.

An observation of a cross-sectional structure and a torsional strength test of the recessed corner part 12a were conducted for the sintered member 10 obtained in Step ST3.

### Comparative Example

The sintered member was manufactured in the same manner as in the embodiment except that Step ST2 was omitted.

As described above, since the brazing material is not used for manufacturing a sintered member according to the comparative example, the penetration part 13 shown in FIG. 2 is not formed on the surface of the recessed corner part 12a in the sintered member according to the comparative example.

An observation of the cross-sectional structure of the recessed corner part 12a and a torsional strength test were also conducted for the sintered member according to the comparative example.

### Result of Observation of Cross-Sectional Structure

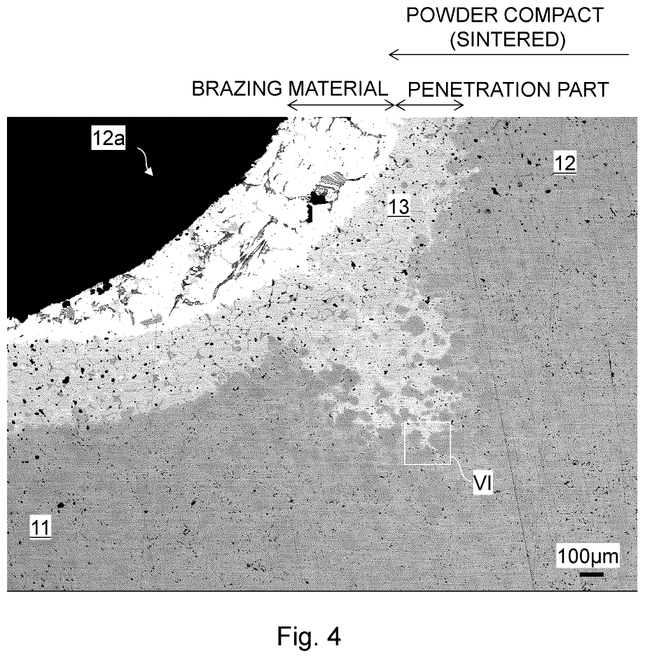

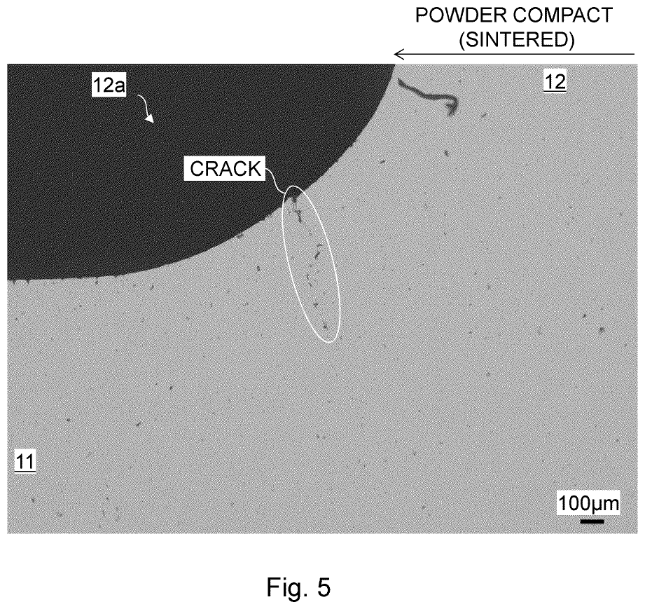

With reference to FIGS. 4 and 5, results of observation of the cross-sectional structure of the sintered member according to the embodiment and that according to the comparative example will be described below. FIG. 4 is a photograph of a cross-sectional structure of a recessed corner part of a stepped part in a sintered member according to the present embodiment. FIG. 5 is a photograph of a cross-sectional structure of a recessed corner part of a stepped part of a sintered member according to the comparative example. FIGS. 4 and 5 are both reflected electron images.

As shown in FIG. 4, in the sintered member 10 according to the embodiment, a brazing material penetrates the surface of the recessed corner part 12a of the stepped part 12 to thereby form the penetration part 13 shown in FIG. 2. In addition, the penetration part 13 is formed to the inside of the powder compact along the crack generated during molding of the powder compact, and it was confirmed that crack has been eliminated.

On the other hand, as shown in FIG. 5, in the sintered member 10 according to the comparative example, it was confirmed that a crack was generated on the surface of the recessed corner part 12a of the stepped part 12.

In FIG. 4, the brazing material remaining on the surface of the recessed corner part 12a of the stepped part 12 does not need to be removed, but may be removed.

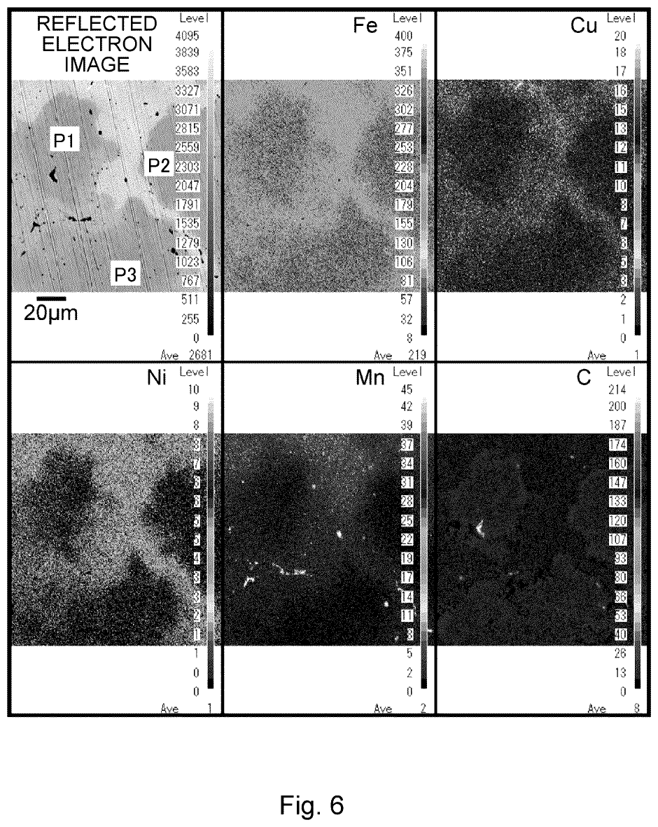

FIG. 6 is a reflected electron image and an elemental mapping image of Fe, Cu, Ni, Mn, and C in region VI of FIG. 4. Each of the elemental mapping images was measured by EPMA (Electron Probe Micro Analyzer).

As shown in FIG. 6, there were three Fe-based alloy particles P1-P3 constituting the powder compact in the observed area, and it was confirmed that the Cu—Ni—Mn-based brazing material penetrated gaps between of the Fe-based alloy particles P1-P3. Near the interface between the Fe-based alloy particles P1-P3 and the brazing material, the concentrations of Fe, Cu, Ni, Mn, etc. gradually change, and it was inferred that they are inter-diffused.

### Result of Torsional Strength Test

The average value of torsional strength of 10 samples of the sintered member 10 according to the Example was 9650 N·m. On the other hand, the average value of the torsional strength of 10 samples of the sintered member in the comparative example was 9320 N·m. Thus, the average value of the torsional strength of the sintered member 10 in the comparative example was higher by 300 Nm on average (3% or higher) than that of the torsional strength of the sintered member according to the comparative example, and all the samples met the standard value of the torsional strength.

As described above, in the sintered member 10 according to the Example, at the time of sintering, at the surface of the recessed corner part 12a of the stepped part 12, a molten brazing material penetrates gaps between particles of metal powder to be sintered. Therefore, a crack and insufficient density generated in the recessed corner part 12a of the stepped part 12 at the time of molding of the powder compact were eliminated, and the strength deficiency of the sintered member 10 obtained by sintering the powder compact could be suppressed.

In the sintered member 10 according to the Example, the density of the powder compact was set to be high so that a crack was generated at the time of molding of the powder compact. As described above, the strength of the sintered member 10 is improved by increasing the density of the powder compact. In the sintered member 10 according to the Example, it was found that even when a crack is generated at the time of molding of the powder compact due to an increase in the density of the powder compact, it is possible to eliminate generation of a crack and insufficient density in the recessed corner part due to the brazing material penetrating gaps between the metal powder particles at the time of sintering. That is, in the sintered member 10 according to the Example, the strength can be improved by increasing the density of the powder compact.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A sintered member comprising a single powder compact made of a metal powder and having a stepped part, the powder compact being obtained by sintering, wherein
at a surface of a recessed corner part of the stepped part, a brazing material penetrates gaps between sintered metal powder particles.

2. The sintered member according to claim 1, wherein
the metal powder is Fe-based metal powder, and
the brazing material is a Cu—Ni—Mn-based brazing material.

3. A method of manufacturing a sintered member, comprising:
preparing a single powder compact made of a metal powder and having a stepped part;
disposing a brazing material on a surface of a recessed corner part of the stepped part; and
sintering the powder compact on which the brazing material is disposed.

4. The method of manufacturing the sintered member according to claim 3, wherein the brazing material is pasty and is disposed on the surface of the recessed corner part of the stepped part by being applied thereon.

5. The method of manufacturing the sintered member according to claim 3, wherein
the metal powder is Fe-based metal powder, and
the brazing material is a Cu—Ni—Mn-based brazing material.
